(19) United States
(12) Patent Application Publication
(10) Pub. No.: US 2010/0064869 A1
(43) Pub. Date: Mar. 18, 2010

(54) DEVICE FOR MEASURING DISTANCE

(76) Inventor: Gregory Scott Poole, Mathews, NC (US)

Correspondence Address: SUMMA, ADDITON & ASHE, P.A., 11610 NORTH COMMUNITY HOUSE ROAD, SUITE 200, CHARLOTTE, NC, 28277, US

(21) Appl. No.: 12/622,525

(22) Filed: Nov. 20, 2009

Related U.S. Application Data
(63) Continuation-in-part of application No. 11/544,393, filed on Oct. 6, 2006, now Pat. No. 7,640,676.

(51) Int. Cl. B26D 5/00; G01B 21/02; G06F 15/00

(52) U.S. Cl. 83/72; 702/163

(57) ABSTRACT

A device for measuring distance includes in one embodiment an electronic rotary encoder having an input shaft, a distance-measuring wheel connected to the input shaft, a base structure connected to the distance-measuring wheel, a frame structure connected to the base structure, a processor in communication with the rotary encoder, and a housing having an electronic digital display for displaying the longitudinal distance traveled by the work piece with an alpha-numeric and graphical representation of the longitudinal distance traveled by the work piece. The distance-measuring wheel reciprocates along a plane that is transverse to a longitudinal axis of the work piece. Advantageously, the display provides the longitudinal distance traveled by the work piece with an alpha-numeric and graphical representation.

### CROSS-REFERENCE TO PRIORITY APPLICATION

This application is a continuation-in-part of and claims the benefit of Non-Provisional patent application Ser. No. 11/544,393 (filed Oct. 6, 2006), which is hereby incorporated by reference in its entirety.

### FIELD OF THE INVENTION

The invention relates to power tools and, in particular, to a measuring device for improving an operator's speed and accuracy when using the power tool.

### BACKGROUND

Conventional power tools, such as miter saws, routers, drill presses and the like, offer a distinct advantage over manually operated tools because they can enhance an operator's precision, accuracy, and efficiency while simultaneously reducing the amount of physical labor required of the operator. As a result, the operator may focus his effort on properly laying out and executing the work to be performed on the work piece. In carpentry, woodworking, metal working and pipe fitting, a power tool operator often lays out the work to be performed on a work piece by using a standard measuring tape to determine the location where the power tool must be applied. After measuring the proper position to apply the power tool, the operator scribes a mark on the work piece with a pencil, pen, marker or other marking tool and then loads the work piece on the power tool to cut or drill into the work piece at the marked position.

Standard measuring tapes are marked in 1/16 inch graduations; however, in precision carpentry, such as cabinetry and furniture making, the 1/16 inch graduations on standard measuring tapes often do not offer an acceptable level of precision, and the carpenter must “eyeball” the measurement when the required distance falls between 1/16 inch graduations. Marking the work piece also inserts a level of imprecision because the operator must account for the thickness of the pencil led or scribing tool when sawing, drilling or routing the work piece. Additionally, when using a saw, the operator must account for the kerf of the saw blade and choose which side of the mark to cut so that the saw blade kerf will not remove too much material from the work piece. This process is inefficient as the carpenter must take the time to measure the distance, mark the work piece, and then stow the measuring tape before actually applying the tool. The present invention seeks to increase a power tool operator's precision and efficiency.

### SUMMARY OF THE INVENTION

In one embodiment of the present invention, a distance measuring device for use with a power tool having an alignment area for receiving a work piece comprises a measuring sensor proximate to said alignment area that produces a first signal corresponding to longitudinal motion of the work piece within the alignment area; a processor that receives the first signal, determines a longitudinal distance traveled by the work piece within the alignment area from the first signal, and outputs a second signal corresponding to the longitudinal distance traveled by said work piece within said alignment area; and a display receiving the second signal from the processor and providing an alpha-numeric representation of the distance traveled by the work piece within the alignment area.

In another embodiment of the present invention, a distance measuring device for use with a power tool having an alignment area for receiving a work piece comprises an electronic rotary encoder located proximate to the alignment area having an input shaft and producing a first signal corresponding to longitudinal motion of the work piece within the alignment area; a distance measuring wheel fixed on said electronic rotary encoder input shaft and having an outer circumferential surface in rolling engagement with an outer surface of the work piece; a processor that receives the first signal, determines a longitudinal distance traveled by said work piece within said alignment area from said first signal, and outputs a second signal that corresponds to the longitudinal distance traveled by the work piece within the alignment area; and an electronic digital display receiving the second signal from said processor and providing an alpha-numeric representation of the distance traveled by the work piece within the alignment area.

In yet another embodiment of the present invention, a power tool having an alignment area has a distance measuring device comprises: a measuring sensor proximate to the power tool alignment area that produces a first signal corresponding to longitudinal motion of the work piece within said alignment area; a processor that receives the first signal, determines a longitudinal distance traveled by the work piece within the alignment area from the first signal, and outputs a second signal that corresponds to the longitudinal distance traveled by the work piece; and a display receiving the second signal from the processor and providing an alpha-numeric representation of the distance traveled by said work piece within alignment area.

In still another embodiment of the present invention, a power tool comprises: a base; an alignment fence; an alignment area defined by said power tool base and said power tool alignment fence for receiving a work piece; and a distance measuring device having an electronic rotary encoder with an input shaft proximate to said alignment area and producing a first signal that corresponds to a longitudinal motion of the work piece within the alignment area; a distance measuring wheel fixed on the electronic rotary encoder input shaft and having an outer circumferential surface in rolling engagement with an outer surface of said work piece; a processor that receives the first signal, determines the longitudinal distance traveled by the work piece within the alignment area from the first signal, and outputs a second signal that corresponds to the longitudinal distance traveled by the work piece within said alignment area; and an electronic digital display receiving the second signal from the processor and providing an alpha-numeric representation of the distance traveled by the work piece within the alignment area.

The accompanying drawings, which are incorporated in and constitute a part of this specification, illustrate one or more embodiments of the invention and, together with the description, serve to explain the principles of the invention

### BRIEF DESCRIPTION OF THE DRAWINGS

The foregoing and other objects and advantages of the invention and the manner in which the same are accomplished will become clearer based on the following detailed description taken in conjunction with the accompanying drawings in which:

FIG. 1 is a front perspective view of a power tool measuring device in accordance with the present invention;

FIG. 2 is a rear perspective view of the power tool measuring device as shown in FIG. 1;

FIG. 3 is a rear view of the power tool measuring device as shown in FIG. 1;

FIG. 4 is a side view of the power tool measuring device as shown in FIG. 1;

FIG. 5A is an enlarged side view of the power tool measuring device as shown in FIG. 1;

FIG. 5B is an enlarged side view of the power tool measuring device as shown in FIG. 1;

FIG. 6 is a front edge view of a second embodiment of power tool measuring device in accordance with the present invention;

FIG. 7 is a top edge view of the power tool measuring device as shown in FIG. 6;

FIG. 8 is an enlarged front perspective view of the power tool measuring device as shown in FIG. 6;

FIG. 9 is an enlarged front perspective view of the power tool measuring device as shown in FIG. 6;

FIG. 10 is a rear perspective view of a third embodiment of the power tool measuring device in accordance with the present invention;

FIG. 11 is an enlarged front perspective view of the power tool measuring device as shown in FIG. 10;

FIG. 12 is a top perspective view of the operation of a power tool measuring device in accordance with the present invention;

FIG. 13 is a top perspective view of the operation of a power tool measuring device in accordance with the present invention;

FIG. 14 is a perspective view of an alternative embodiment of an apparatus for measuring distance according to one aspect of the present invention;

FIG. 15 is a perspective view of one embodiment of the present invention;

FIG. 16 is an enlarged cross-sectional view taken along line 16-16 of FIG. 15 of one embodiment of the present invention;

FIG. 17A is an enlarged partial side view of a work piece abutting a blade of a miter saw;

FIG. 17B is an enlarged partial side view of the work piece after the saw blade has cut the work piece resulting in a work piece having a total length (TL);

FIG. 18A is a front view of a display in accordance with the present invention reset to 0 inches when the work piece of FIG. 17A abuts the saw blade; and

FIG. 18B is a front view of a display in accordance with the present invention indicating a total length of 12 inches for the piece of the work piece cut by the saw blade.

### DETAILED DESCRIPTION

The present invention will now be described more fully hereinafter with reference to the accompanying drawings, in which a preferred embodiment of the invention is shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

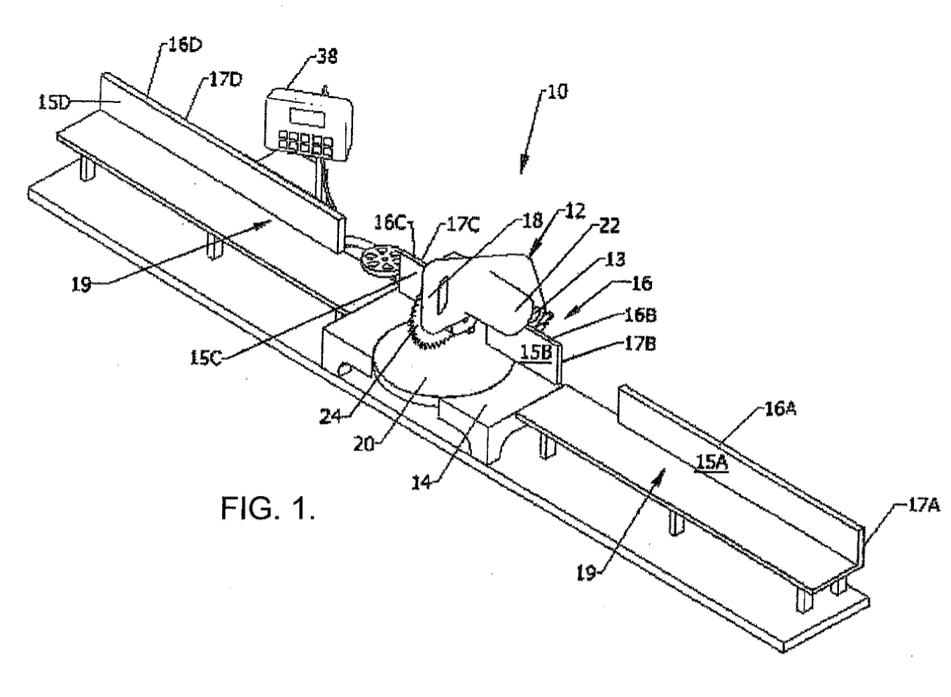

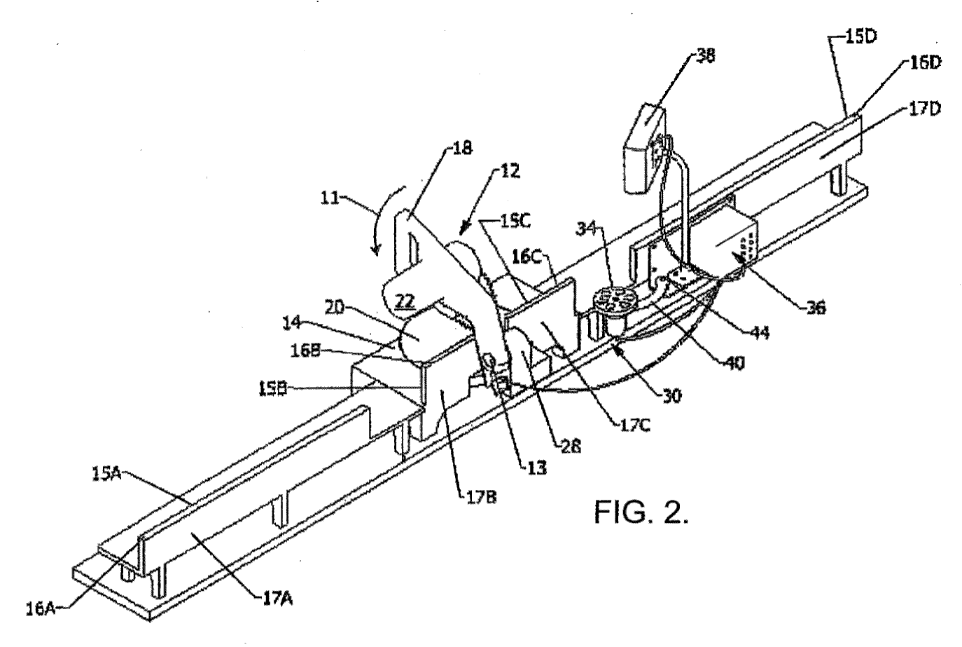

Referring to FIGS. 1 and 2, an embodiment of power tool measuring device 10 of the present invention is shown configured for use with a standard miter saw 12 equipped with a base 14 having an alignment fence 16 that extends vertically from the base. In the present embodiment, measuring device 10 is used with a miter saw, but it should be understood that the measuring device may be used in conjunction with any power tool having an alignment fence, such as a drill press, a router table, or other similar tool. Miter saw 12 preferably has a base 14, an alignment fence 16, a handle assembly 18 and a selectively rotatable table 20. A handle assembly 18 supports a motor 22 with an output shaft 21 (FIG. 4) that is rotationally fixed to a saw blade 24. Handle assembly 18 is pivotally connected to a table 20 by a pivot pin 13 received in a support hub 28 (FIG. 2) that extends vertically from the rear of table 20. A torsional handle spring (not shown) biases handle assembly 18 towards an upright position such that handle assembly will only rotate downward in the direction of arrow 11 (FIG. 2) when the operator applies a downward force on the handle assembly.

In one embodiment, fence 16 has multiple sections 16A, 16B, 16C, and 16D, although it should be understood that fence 16 may also be a single section spanning the entire length of miter saw base 14. Each fence section 16A, 16B, 16C, and 16D has a respective forward facing surface 15A, 15B, 15C, and 15D, and a respective rearward facing surface 17A, 17B, 17C, and 17D. The forward facing surfaces of the fence sections define an alignment area 19 (FIG. 1) that allows the saw operator to properly align a work piece (not shown) and slide the work piece longitudinally until the work piece is properly positioned for cutting.

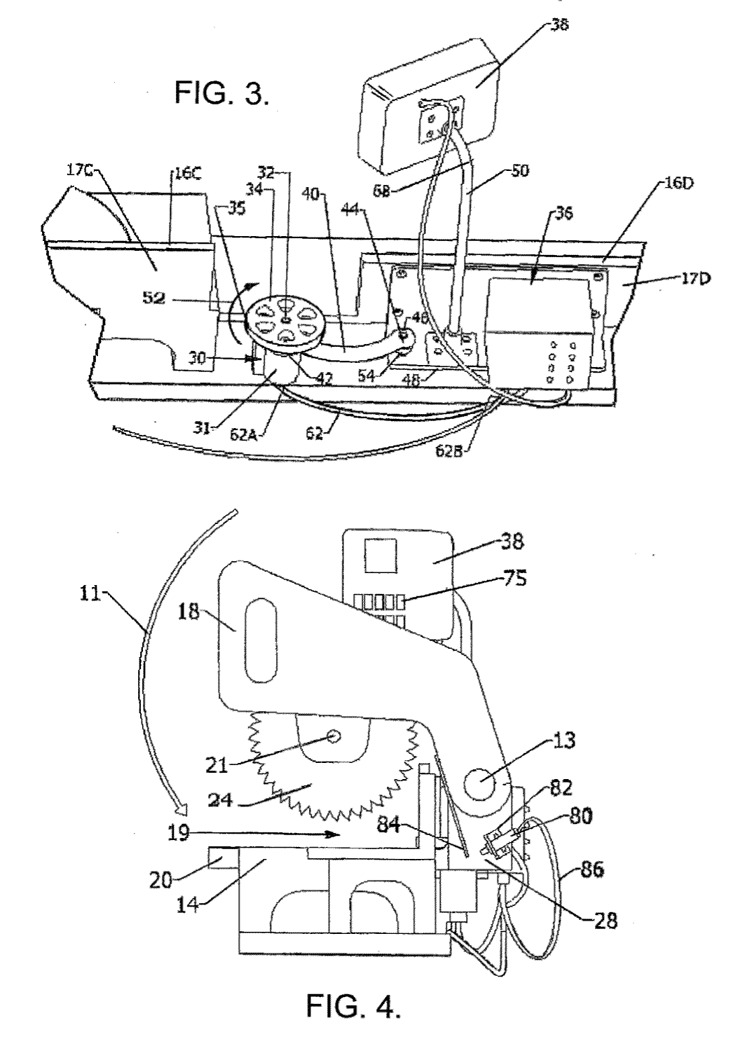

Referring to FIGS. 2 and 3, measuring device 10 includes a measuring sensor 30 (in this embodiment a rotary encoder) having an input shaft 32 (FIG. 3), a measuring wheel 34, a processor 36, and a display 38. Referring specifically to FIG. 3, a pivot arm 40 defines a first end 42 that supports measuring sensor 30 and a second end 44 that is pivotally attached to a pivot post 46. The pivot post extends vertically from a support bracket 48 that is rigidly mounted to rearward facing surface 17D of alignment fence section 16D. Support bracket 48 provides rigid support to processor 36 and display 38 by means of a display support member 50. Support bracket 48 is positioned so that measuring wheel 34 is disposed between alignment fence sections 16C and 16D.

In a preferred embodiment, pivot arm 40 is biased by a torsion spring 54 that surrounds pivot post 46 and has a first end (not shown) rigidly attached to pivot arm second end 44 and a second end (not shown) rigidly attached to support bracket 48. A torsion load is applied to torsion spring 54 during assembly such that the engagement between torsion spring second end (not shown) and support bracket 48 biases torsion spring first end (not shown) in a manner that urges pivot arm first end 42 in the direction of arrow 52 so that measuring wheel circumferential surface 35 extends into alignment area 19. In a preferred embodiment, torsion spring 54 is selected to have a spring constant small enough to allow pivot arm 40 and measuring wheel 34 to articulate in the direction opposite to arrow 52 when measuring wheel circumferential surface 35 encounters the edge of a work piece. However, torsion spring 54 should be strong enough that it urges measuring wheel 34 into continuous rolling engagement with the edge of the work piece as the work piece is maneuvered longitudinally within alignment area 19 (FIGS. 1 and 2). It should be understood that any suitable biasing element may be substituted for the torsion spring, such as a linear compression spring, a hydraulic cylinder, or other similar device.

As previously mentioned, measuring sensor 30 has an input shaft 32 that is fixed to measuring wheel 34 so that the input shaft and the measuring wheel rotate in unison. Preferably, measuring sensor 30 is an electronic rotary encoder 31 that generates signal pulses as input shaft 32 rotates as described in further detail below. While the operation of rotary encoder 31 is not considered part of the invention, one of skill in the art should be familiar with their operation and recognize a suitable example of such an encoder to be the Allen-Bradley 845P Size 15 Incremental Encoder. The signal pulses are transmitted from rotary encoder 31 to processor 36 by means of a first communication cable 62. Communication cable 62 has a first end 62A received by a rotary encoder output port 60 and a second end 62B received by processor 36. In a preferred embodiment, processor 36 is a central processing unit (CPU) (not shown) equipped with a microprocessor, integrated counting circuit, or electronic analog circuit programmed to interpret the pulses generated by rotary encoder 31 as signaling a linear distance. The CPU transmits information, including the processed signal pulses, through a second communications cable 68 to display 38. While measuring device 30 is described in detail as a rotary encoder, it should be understood that any suitable rotation motion measuring device, such as a mechanical click-wheel, a linear encoder, or other similar device may be used.

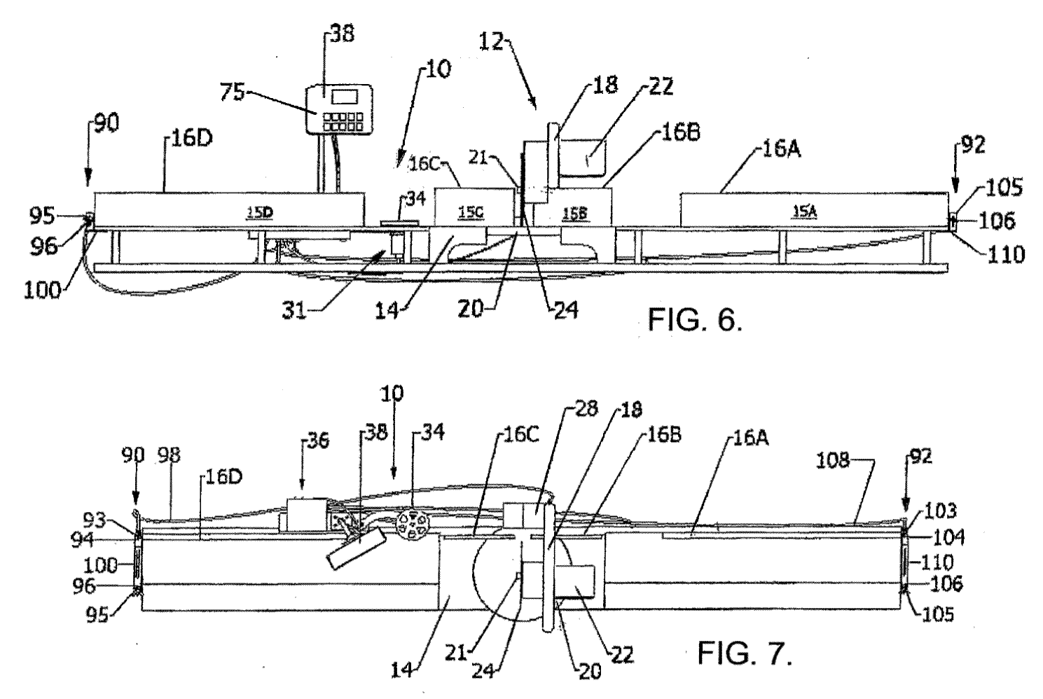

Processor 36 transmits output information to display 38 so that the operator may read and interpret the measurements taken by measuring device 30. In a preferred embodiment, display 38 is a digital display that shows the operator an alpha-numeric representation of the length that the work piece has moved longitudinally within alignment area 19 (FIGS. 1 and 2). Display 38 may also be equipped with an input keypad 75 (FIGS. 4 and 6) that the operator may use to input information to CPU 37, such as the kerf of a newly installed saw blade. The operator may also use keypad 75 (FIGS. 4 and 6) to direct the CPU to display the displacement of the work piece in English or Metric units or manually override the CPU functions.

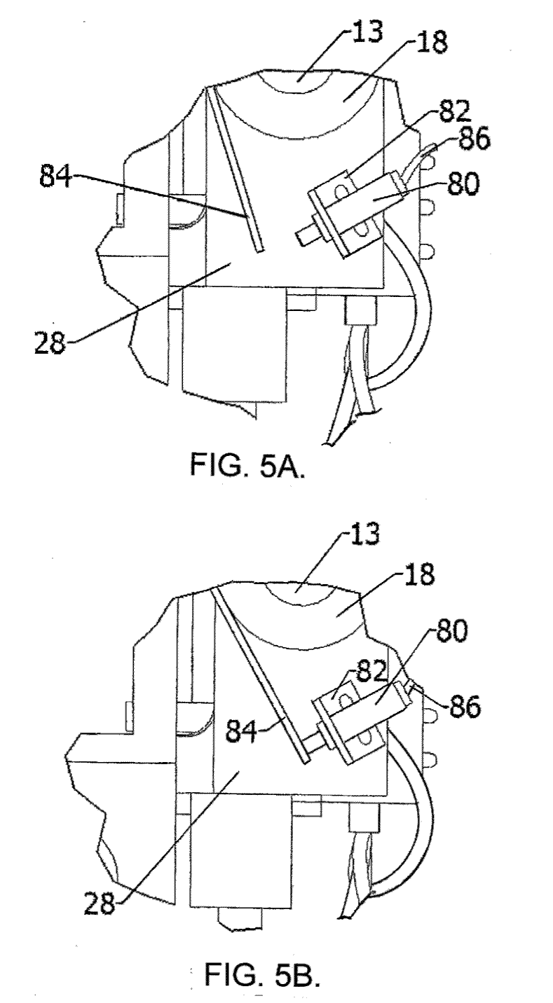

Referring to FIGS. 4, 5A and 5B, a proximity switch 80, which may be an optical sensor, a magnetic sensor, or other similar sensing device, is fixed to a bracket 82 mounted on support hub 28. Handle assembly 18 supports a flag 84 mounted proximate to pivot pin 13 so that proximity switch 80 may selectively sense the presence of flag 84. When saw handle assembly 18 is in its normal position, as shown in FIGS. 4 and 5A, the distance between flag 84 and proximity switch is great enough to prevent the switch from sensing the flag's presence. However, when the operator rotates the handle assembly into the cutting position, flag 84 moves into a position where proximity switch 80 can easily sense the flag's presence, as shown in FIG. 5B. The proximity switch then generates a signal indicating that the saw handle assembly is in the cutting position, and the output signal from proximity switch 80 is transmitted to CPU 37 (FIG. 2) by a communication cable 86, as discussed in further detail below.

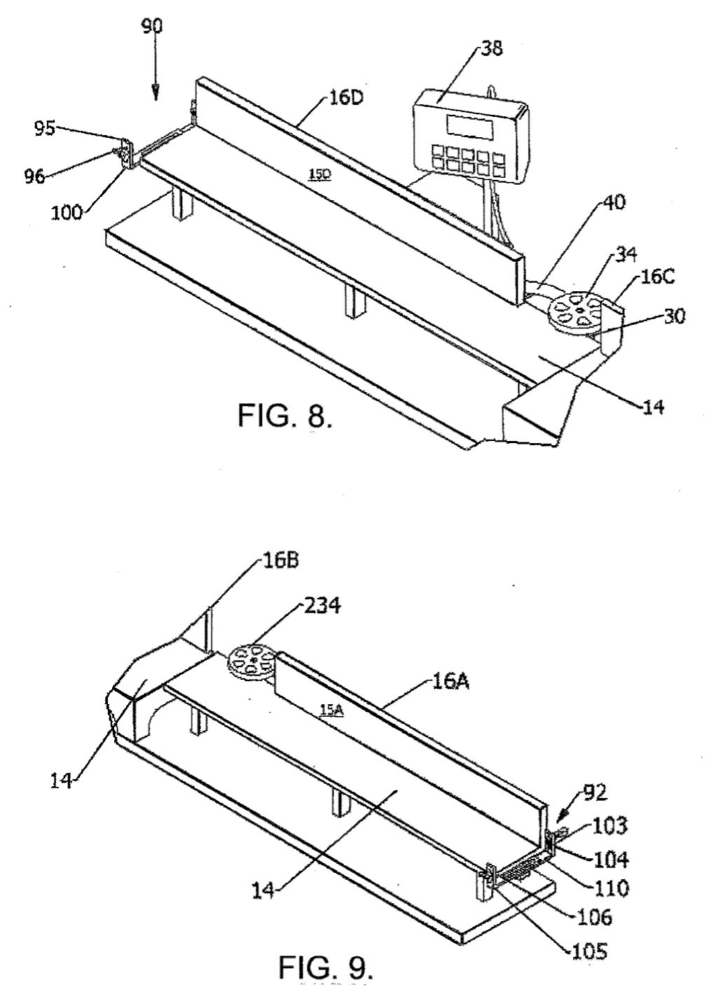

Referring to FIGS. 6 and 7, and embodiment of the power tool measuring device 10 having a first deployable stop 90 and an optional second deployable stop 92. First deployable stop 90 and optional second deployable stop 92 perform the function of sending an indication signal to the CPU when a work piece has been loaded onto the power tool base as described in detail below. In a preferred embodiment, and as discussed below, first deployable stop 90 is a standard through-beam photoelectric sensor having an emitter 94 (FIGS. 7 and 8), a reflector 96, and a communications cable 98 that relays the signal produced by emitter 94 to CPU 37 (FIG. 7). Emitter 94 produces an infrared light beam that is focused on reflector 96. When no objects is placed between emitter 94 and reflector 96, the light beam is reflected by the reflector and returns to the emitter, which receives the light beam and sends a continuous signal to the CPU. If an object is placed between the emitter and the reflector, the light beam is not reflected to the emitter, and the emitter no longer sends a signal to the CPU. The CPU interprets the condition where no signal is sent from first deployable stop 90 as an indication that a work piece has been loaded on the left-hand side of power tool 12. While deployable stop 90 is preferably a standard through-beam photoelectric sensor, any suitable sensor may be substituted, such as a diffuse reflective photoelectric sensor, a polarized reflex photoelectric sensor, or a mechanical gate-type sensor.

Referring to FIGS. 7 and 8, a first mounting bracket 100 preferably provides rigid support to first deployable stop 90 and has a first arm 93 that supports emitter 94 and a second arm 95 that supports reflector 96. First mounting bracket 100 is rigidly attached to the underside of power tool base 14 proximate to alignment fence section 16D.

Referring now to FIGS. 6, 7, and 9, optional second deployable stop 92 is preferably also a standard through-beam photoelectric sensor that operates identically to the sensor described above in accordance with the first deployable stop. Optional second deployable stop 92 has an emitter 104 (FIGS. 7 and 9), a reflector 106, and a communications cable 108 that relays the signal produced by emitter 104 to CPU 37 (FIG. 7). Emitter 104 produces an infrared light beam that is focused on reflector 106. Under normal operation, the light beam is reflected by the reflector and returns to the emitter, which receives the light beam and sends a continuous signal to the CPU; however, if an object is placed between emitter 104 and reflector 106, the light beam is not reflected to the emitter, and the emitter no longer sends a signal to the CPU. The CPU interprets the condition where no signal is sent from optional second deployable stop 92 as an indication that a work piece has been loaded on the right-hand side of power tool 12. It should be understood that any suitable sensor may be substituted for emitter 104 and reflector 106, such as a diffuse reflective photoelectric sensor, a polarized reflex photoelectric sensor, or a mechanical gate-type sensor.

Referring specifically to FIGS. 7 and 9, a second mounting bracket 110 preferably provides rigid support to optional second deployable stop 92, and has a first arm 103 that supports emitter 104 and a second arm 105 that supports reflector 106. Second mounting bracket 110 is rigidly attached to the underside of power tool base 14 proximate to alignment fence section 16A.

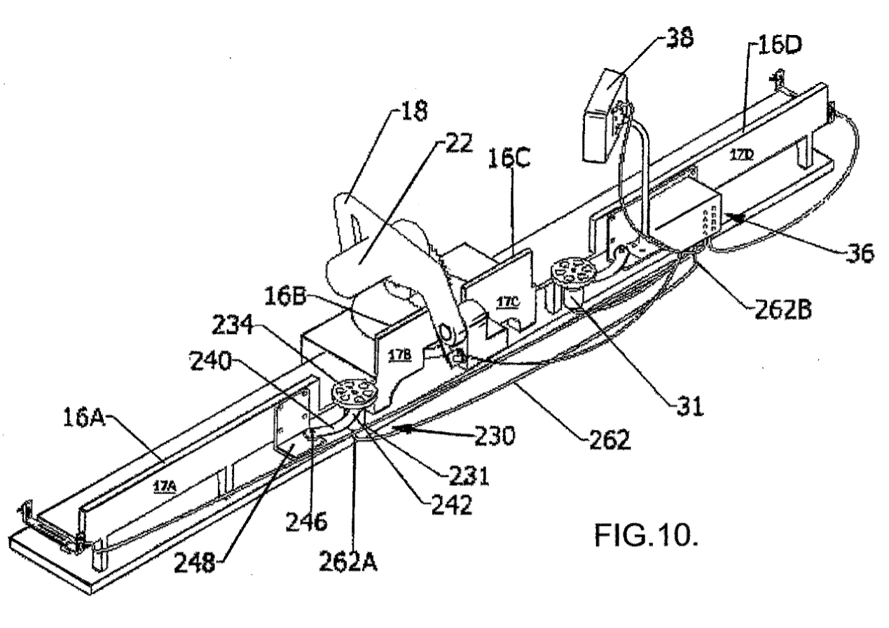

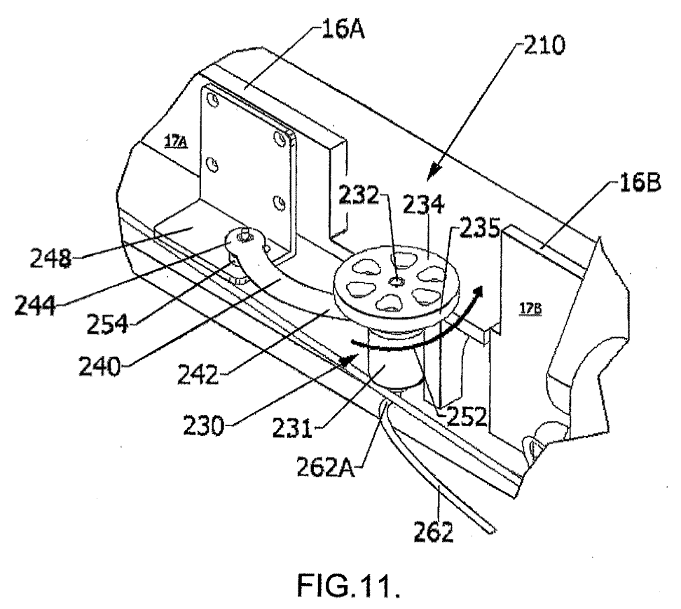

Referring to FIGS. 10 and 11, an embodiment of a power tool measuring device has an optional second measuring device 210 that is similar to measuring device 10 discussed above. Second measuring device 210 has a sensor 230 with an input shaft 232 (FIG. 11), a measuring wheel 234 with an outer circumferential surface 235, and a second a pivot arm 240. The second pivot arm 240 has a first end 242 that supports measuring sensor 230 and a second end 244 that is pivotally attached to a pivot post 246. The pivot post extends vertically from a support bracket 248 rigidly mounted to alignment fence rearward facing surface 17A. The support bracket is positioned so that measuring wheel 234 is disposed between alignment fence sections 16A and 16B.

Referring to FIG. 11, in a preferred embodiment, pivot arm 240 is biased in a direction represented by arrow 252 by a torsion spring 254. The torsion spring surrounds pivot post 246 and has a first end (not shown) rigidly attached to pivot arm 240 and a second end (not shown) rigidly attached to support bracket 248. A torsion load is applied to torsion spring 254 during assembly such that the engagement between torsion spring second end (not shown) and support bracket 248 biases spring first end (not shown) in a manner that urges pivot arm first end 242 in the direction of arrow 252. The biasing action of torsion spring 254 urges pivot arm first end 242 and measuring wheel 234 into alignment area 19. Preferably, torsion spring 254 is selected to have a spring constant small enough to allow pivot arm 240 and measuring wheel 234 to articulate in the direction opposite to arrow 252 when the outer circumferential surface 235 of measuring wheel 234 encounters the edge of a work piece. However, torsion spring 254 should be strong enough that it urges measuring wheel 234 into continuous rolling engagement with the edge of the work piece as the work piece is maneuvered along longitudinal axis 19A (FIG. 19A). It should be understood that any suitable biasing element may be substituted for the torsion spring, such as a linear compression spring, a hydraulic cylinder, or some other similar device.

Second pivot arm first end 242 supports second sensor 230, which is preferably a digital rotary encoder 231. Measuring wheel 234 is fixed to rotary encoder input shaft 232 so that the measuring wheel and the input shaft rotate in unison. As input shaft 232 rotates, rotary encoder 231 generates signal pulses as described in further detail below. The signal pulses are transmitted from the rotary encoder counting device 231 by a communication cable 262. Preferably, both measuring wheel 234 and rotary encoder 231 be identical in size and resolution to measuring wheel 34 and rotary encoder 31 (FIG. 10), respectively; however it should be understood that measuring wheel 234 and rotary encoder 231 may be of different size and resolution and that rotary encoder 231 or the CPU may be calibrated to account for the differences in measuring wheel size and encoder resolution.

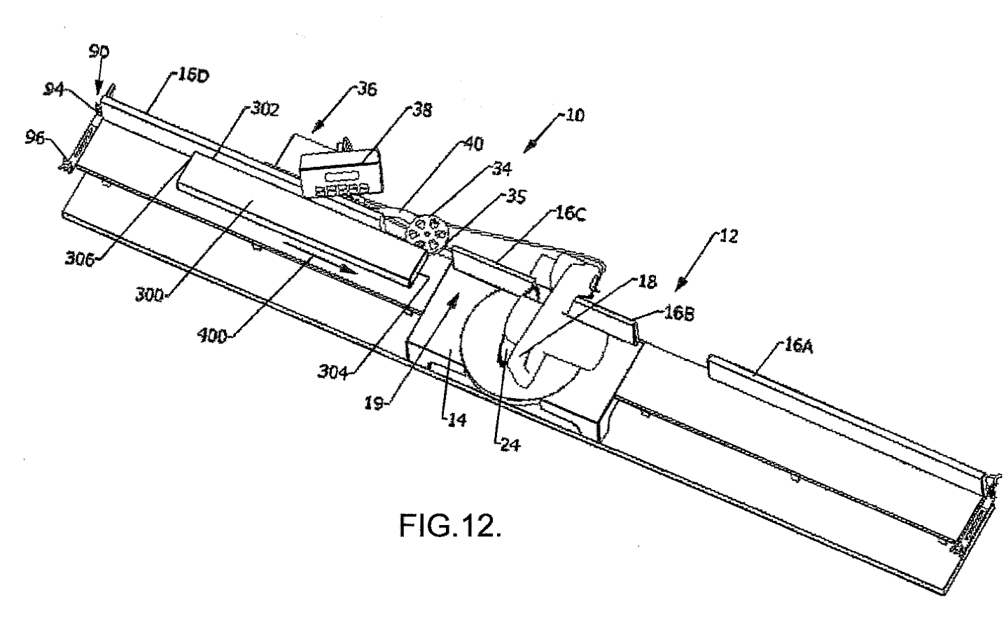

In operation of a preferred embodiment of the power tool measuring device 10, and referring to FIG. 12, the operator loads a work piece 300 onto the power tool base 14 such that an edge 302 of the work piece proximate to alignment fence section 16D is positioned flush against the alignment fence forward facing surface 15D. Work piece 300 has an end 304 positioned proximate to the left-hand side of saw blade 24, and an end 306 positioned distal from the left-hand side of the saw blade. As work piece 300 is loaded into alignment area 19, edge 302 comes into contact with the measuring wheel outer circumferential surface 35. To properly align edge 302 with alignment fence section 16D, pivot arm 40 must rotate in a direction opposite of arrow 52 against the bias of torsion spring 54 (FIG. 3). In this way, torsion spring 54 provides resistance against further rotation of pivot arm 40 and ensures that measuring wheel outer circumferential surface 35 remains in constant rolling engagement with work piece edge 302.

When work piece edge 302 is properly positioned against the alignment fence section 16D, deployable stop 90 senses work piece 300 when the work piece passes between the deployable stop's emitter 94 and reflector 96 and breaks the photoelectric beam produced by the emitter and causing the emitter to stop sending its signal to the CPU. The CPU interprets the interruption in the signal from deployable stop 90 to mean that a cutting process is imminent, and that the operator has loaded the work piece on the power tool at a position to the left of the saw blade. Because the presence of the work piece interrupted the signal produced by first deployable stop 90, the CPU chooses to read and process only the output signal generated by rotary encoder 31 (FIG. 3), which will correspond to the longitudinal distance traveled by the work piece in alignment area 19. If the operator is using an embodiment of the power tool measuring device that does not include a first deployable stop 90, the operator may use keypad 75 (FIGS. 4 and 6) provided on display 38 to input information to the CPU that indicates that a work piece has been loaded on the left-hand side of power tool 12 and that the CPU should process cut length information received from rotary encoder 31.

After the CPU recognizes an interruption in the signal from the first deployable stop, the CPU waits for an input signal from handle assembly proximity switch 80. As part of the pre-cut routine, the operator rotates handle assembly 18 in the direction of arrow 11 (FIG. 4) until saw blade 24 is placed in the cutting position. Referring to FIGS. 4 and 5B, once handle assembly 18 is fully rotated into the cutting position, proximity switch 80 senses the presence of flag 84 and sends a signal to the CPU that the handle assembly has been put in the cutting position. Once the CPU receives the signal from proximity switch 80, the CPU resets and holds the display 38 (FIG. 4) so that it shows a cut distance reading of zero. While handle assembly 18 is in the cutting position, the CPU holds the display reading at zero even though rotary encoder may generate output signal pulses because the CPU will recognize that the signal pulses generated by the rotary encoder are the result of the operator moving the work piece to a zero-point location. The operator places the work piece in zero-point location by sliding the work piece 300 along alignment fence 16 in the direction of arrow 400 until work piece end 304 engages the left-hand side of saw blade 24. In this way, the work piece is located such that the zero reading shown on display 38 properly reflects the fact that work piece end 304 is directly adjacent to the saw blade in the zero-point location.

Once the operator places work piece 300 in the zero-point location, the operator then returns handle assembly 18 to its resting position, and proximity switch 80 no longer senses the presence of flag 84, causing an interruption in the signal produced by proximity switch 80. The CPU recognizes the interruption of the signal from proximity switch 80 as an indication that the operator has placed the work piece is the zero-point location and that cut measurement is about to begin. The CPU then actively receives and interprets output signal pulses generated by the rotary encoder. As the operator slides work piece 300 in the direction of arrow 400, the rolling engagement between measuring wheel outer circumferential surface 35 and work piece edge 302 forces rotary encoder input shaft 32 (FIG. 3) to rotate. As the rotary encoder input shaft rotates, output signal pulses are generated by the rotary encoder 31 and transmitted to the CPU. The CPU reads and interprets the pulses from rotary encoder 31 (FIG. 3) and processes the signal pulses from the rotary encoder into a display signal that represents the longitudinal movement of the work piece. The CPU then sends the display signal to display 38, where the signal is shown as a numerical representation of the length the operator has moved work piece from its original zero point location. The rolling engagement between measuring wheel outer circumferential surface 35 and work piece edge 302 forces rotary encoder input shaft 32 (FIG. 3) to rotate in response to movement of work piece edge 302 in direction of arrow 400.

The operation of the rotary encoder will now be described in detail. In a preferred embodiment, rotary encoder 31 generates approximately 360 pulses for each full rotation of measuring wheel 34 and input shaft 31 (FIG. 3). The measuring wheel preferably has a circumference of approximately 11.25 inches so that one full rotation of the measuring wheel corresponds to a work piece displacement of approximately 11.25 inches along longitudinal axis 19A. This combination of rotary encoder resolution and measuring wheel circumference is advantageous because a one-inch linear movement of the work piece along longitudinal axis 19A results in the generation of 32 pulses: that is to say that the rotary encoder generates one pulse for each thirty-second of an inch that work piece 300 moves along axis 19A in the direction of arrow 400. The CPU receives the pulses generated by the rotary encoder, and sums the total number of pulses received from the rotary encoder. In this way, each new pulse received by the CPU is added to the sum of all previously received pulses to create a new sum. The CPU simultaneously stores the new sum, which corresponds to the total distance the work piece has traveled in the direction of arrow 400, and relays the new sum to display 38, where the digital output shows the total cut distance in both full inches and thirty-seconds of an inch. Increasing or decreasing either resolution of rotary encoder 31 or the circumference of measuring wheel 34 will result in a measuring device having a different resolution. For example, using a rotary encoder with a resolution of 90 pulses per input shaft rotation and a measuring wheel with a circumference of 5.625 inches yield a measuring device that generates one pulse for each sixteenth of an inch movement of the work piece. Similarly, a measuring wheel and rotary encoder combination may be selected that will display the cut distance in metric units.

As the operator slides the work piece in the direction of arrow 400, the power tool display 38 provides a precise indication of the cut distance. Once the operator is satisfied that the proper cut distance has been achieved, the operator activates the saw motor, and rotates handle assembly 18 in the direction of arrow 11 (FIG. 4) until the saw blade cuts completely through the work piece. As described above, rotation of the handle assembly into the cutting position causes proximity switch 80 to sense the presence of flag 84 (FIG. 5B) and send a signal to the CPU. The CPU recognizes the signal from proximity switch 80 as indicating that the cutting function is being performed. After the cut has been performed, the operator removes two cut pieces of the work piece from the miter saw 12 and returns handle assembly 18 to its resting position, thus removing flag 84 from proximity switch 80 and interrupting the signal sent from proximity switch 80 to the CPU. The CPU interprets this interruption as an indication that the cutting function has been performed, and the CPU holds the display 38 so that the display shows only distance measurement value shown on the display at the time that proximity switch 80 sensed flag 84 when the cut was performed. In this way, display 38 will continue to show the cut measurement from the prior cut until a new work piece is loaded into the alignment area and the signal from deployable stop 90 is interrupted once again.

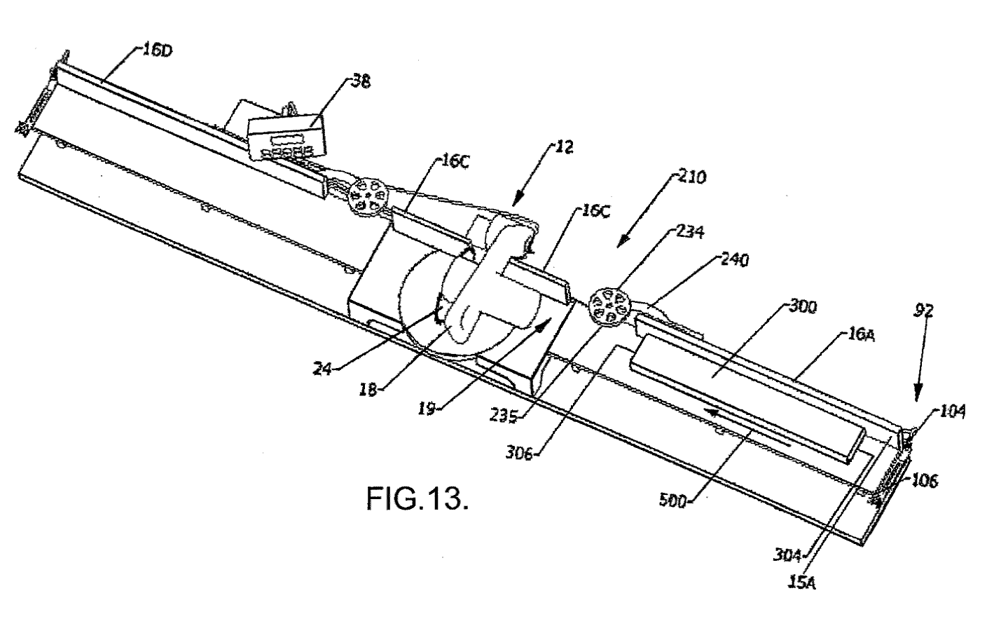

Referring to FIG. 13, when the operator is using a power tool measuring device having an optional second measuring device 230, the operator may choose to load work piece 300 onto the power tool base 14 such that edge 302 of the work piece proximate to alignment fence section 16A is positioned flush against the alignment fence forward facing surface 15A. Work piece end 306 is positioned proximate to the right-hand side of saw blade 24, and work piece end 304 is positioned distal from the right-hand side of the saw blade. As work piece 300 is loaded into alignment area 19, edge 302 comes into contact with the measuring wheel outer circumferential surface 235. To properly align edge 302 with alignment fence section 16A, pivot arm 240 must rotate in a direction opposite of arrow 252 against the bias of torsion spring 254 (FIG. 9). In this way, torsion spring 254 provides resistance against further rotation of pivot arm 240 while ensuring that measuring wheel outer circumferential surface 235 remains in constant rolling engagement with work piece edge 302.

When work piece edge 302 is properly positioned against the alignment fence section 16A, optional second deployable stop 92 senses work piece 300 when the work piece passes between the deployable stop's emitter 94 and reflector 96 and breaks the photoelectric beam produced by the emitter and causing the emitter to stop sending its signal to the CPU. The CPU interprets the interruption in the signal from optional second deployable stop 92 to mean that a cutting process is imminent, and that the operator has loaded the work piece on the power tool at a position to the right of the saw blade. Because the presence of the work piece interrupted the signal produced by second deployable stop 92, the CPU chooses to read and process only the output signal generated by optional second rotary encoder 231 (FIG. 3), which will correspond to the longitudinal distance traveled by the work piece in alignment area 19. The CPU will not read and process the output signal generated by first rotary encoder 31 when the signal from second deployable stop 92 is interrupted until the CPU resets itself at the completion of the cutting process, as described below. If the operator is using an embodiment of the power tool measuring device that does not include an optional second deployable stop 92, the operator may use keypad 75 (FIGS. 4 and 6) provided on display 38 to input information to the CPU that indicates that a work piece has been loaded on the right-hand side of power tool 12 and that the CPU should process cut length information received from second rotary encoder 231.

After the CPU recognizes an interruption in the signal from the first deployable stop, the CPU waits for an input signal from handle assembly proximity switch 80. As part of the pre-cut routine, the operator rotates handle assembly 18 in the direction of arrow 11 (FIG. 4) until saw blade 24 is placed in the cutting position. Referring to FIGS. 4 and 5B, once handle assembly 18 is fully rotated into the cutting position, proximity switch 80 senses the presence of flag 84 and sends a signal to the CPU that the handle assembly has been put in the cutting position. Once the CPU receives the signal from proximity switch 80, the CPU resets and holds the display 38 (FIG. 4) so that it shows a cut distance reading of zero. While handle assembly 18 is in the cutting position, the CPU holds the display reading at zero even though optional second rotary encoder 231 may generate output signal pulses because the CPU will recognize that the signal pulses generated by the rotary encoder are the result of the operator moving the work piece to a zero-point location. The operator places the work piece in zero-point location by sliding the work piece 300 along alignment fence 16 in the direction of arrow 500 until work piece end 306 engages the right-hand side of saw blade 24. In this way, the work piece is located such that the zero reading shown on display 38 properly reflects the fact that work piece end 304 is directly adjacent to the saw blade in the zero-point location.

After placing work piece 300 in the zero-point location, the operator then returns handle assembly 18 to its resting position, and proximity switch 80 no longer senses the presence of flag 84, causing an interruption in the signal produced by proximity switch 80. The CPU recognizes the interruption of the signal from proximity switch 80 as an indication that the operator has placed the work piece is the zero-point location and that cut measurement is about to begin. The CPU then actively receives and interprets output signal pulses generated by second rotary encoder 231. As the operator slides work piece 300 in the direction of arrow 500, the rolling engagement between measuring wheel outer circumferential surface 235 and work piece edge 302 forces second rotary encoder input shaft 232 (FIG. 11) to rotate. As the second rotary encoder input shaft rotates, output signal pulses are generated by the second rotary encoder 231 and transmitted to the CPU. The CPU reads and interprets the pulses from the second rotary encoder and processes the signal pulses into a display signal that represents the longitudinal movement of the work piece. The CPU then sends the display signal to display 38, where the signal is shown as a numerical representation of the length the operator has moved work piece from its original zero point location. The rolling engagement between second measuring wheel outer circumferential surface 235 and work piece edge 302 forces second rotary encoder input shaft 232 (FIG. 11) to rotate in response to movement of work piece edge 302 in direction of arrow 500.

As the operator slides the work piece in the direction of arrow 500, the power tool display 38 provides a precise indication of the cut distance. Once the operator is satisfied that the proper cut distance has been achieved, the operator activates the saw motor, and rotates handle assembly 18 in the direction of arrow 11 (FIG. 4) until the saw blade cuts completely through the work piece. As described above, rotation of the handle assembly into the cutting position causes proximity switch 80 to sense the presence of flag 84 (FIG. 5B) and send a signal to the CPU. The CPU recognizes the signal from proximity switch 80 as indicating that the cutting function is being performed. After the cut has been performed, the operator removes two cut pieces of the work piece from the miter saw 12 and returns handle assembly 18 to its resting position, thus removing flag 84 from proximity switch 80 and interrupting the signal sent from proximity switch 80 to the CPU. The CPU interprets this interruption as an indication that the cutting function has been completed, and the CPU holds the display 38 so that the display shows only distance measurement value shown on the display at the time that proximity switch 80 sensed flag 84 when the cut was performed. In this way, display 38 will continue to show the cut measurement from the prior cut, and CPU will not begin to read output signal pulses from either of the rotary encoders until the CPU resets itself when a new work piece is loaded into the alignment area and interrupts the signal from either deployable stop 90 or optional second deployable stop 90.

It should be recognized that the power tool measuring device described above does not account for the kerf of saw blade 24. The CPU may be programmed to provide a function that allows the operator to input the saw blade kerf into the CPU's memory each time a new saw blade is installed onto the saw motor output shaft. In an embodiment where display 38 is equipped with an input key pad 75 as shown in FIGS. 4 and 6, the operator may measure the saw blade kerf and then enter the measurement into the CPU's memory through key pad 75. When either of the first or second deployable stops is activated, the CPU recalls the kerf measurement value and subtracts it from the cut measurement relayed to the CPU from the rotary encoder the CPU has chosen to read. In this way, the cut measurement shown on display 38 is corrected to account for the saw blade kerf.

When the power tool measuring device is used with miter saws having a selectively rotatable table 20 (FIG. 1) that allows for angled or beveled cuts, a rotary encoder (not shown) may be installed at the table's point of rotation. This rotary encoder senses the rotation of table 20 at the table's point of rotation. When the operator rotates the table such that the saw blade is skewed from its normal position perpendicular to alignment fence 16 (FIG. 1), the rotary encoder sends a signal to the CPU that corresponds to the angular displacement of the table. Based upon the known saw blade kerf, the CPU uses simple geometric algorithms to correct the cut measurement to account for both saw blade kerf and the angle of the saw blade with respect to alignment fence 16.

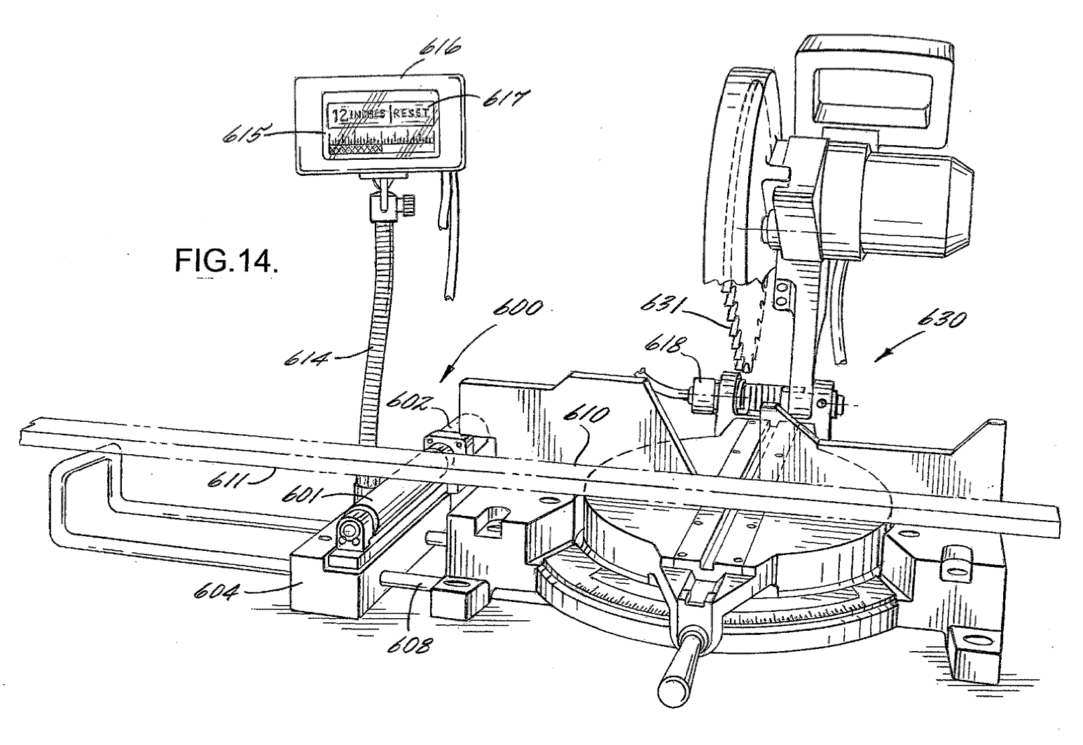

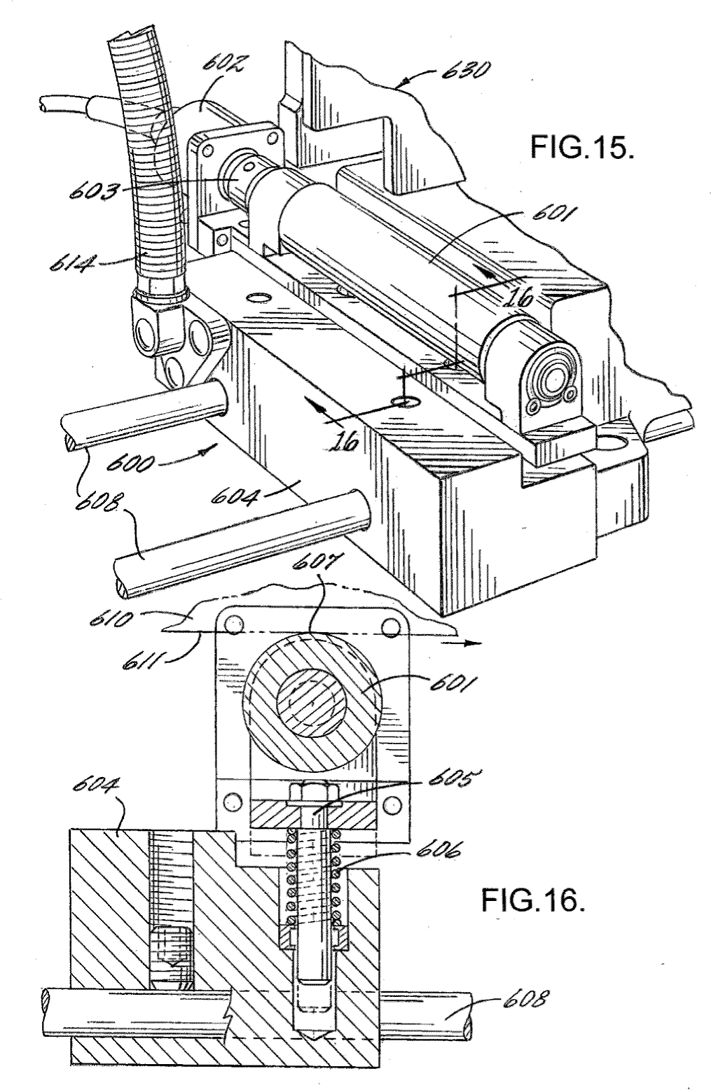

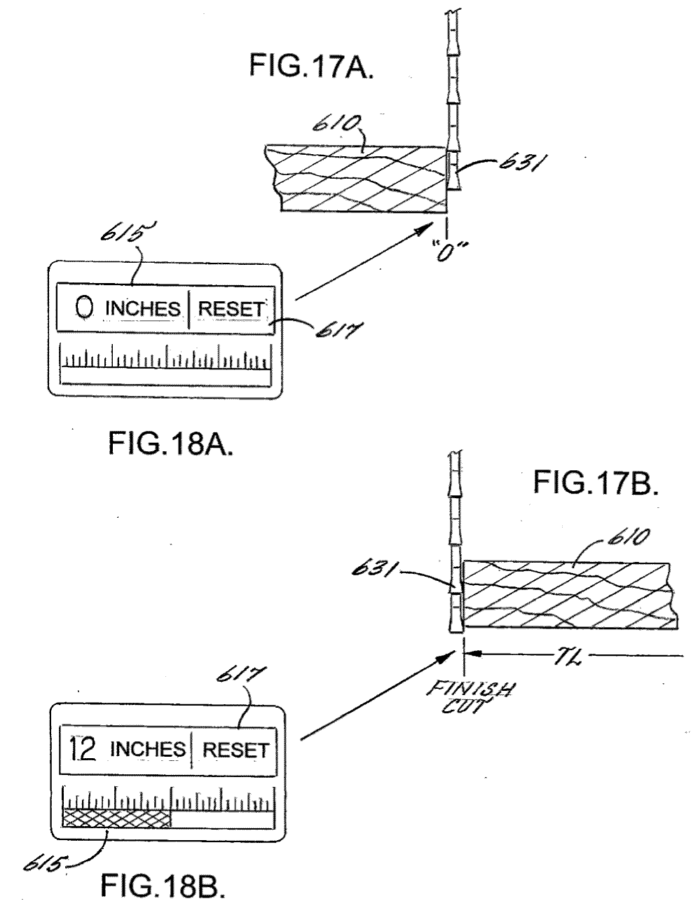

An alternative embodiment of the present invention is depicted in FIGS. 14-18B, namely a device for measuring distance 600. This device 600 measures distance, such as the longitudinal distance traveled by a work piece 610.

As depicted in FIGS. 14-18B, the device for measuring distance 600 may include a distance-measuring wheel 601 connected to an encoder 602 by an input shaft 603. FIG. 15 depicts the distance-measuring wheel 601 being a cylindrical roller. That said, other distance-measuring wheels are within the scope of the present invention.

The electronic rotary encoder 602 may produce a first signal that corresponds to the longitudinal motion of the work piece 610 as the work piece 610 moves across the distance-measuring wheel 601. In one embodiment, the electronic rotary encoder 602 continuously produces the first signal as the work piece 610 moves across the distance-measuring wheel 601.

The distance-measuring wheel 601 and the encoder 602 may be connected to a base structure 604 (e.g., with one or more bolts 605). In one embodiment, the distance-measuring wheel 601 is depressibly connected to the base structure 604 (e.g., with one or more springs 606). In other words, the distance-measuring wheel 601 may reciprocate (i.e., be depressed) along a plane that is transverse to a longitudinal axis of a work piece 610 being measured by the device 600. By way of illustration, a work piece 610 may be placed on the distance-measuring device 600 such that the outer circumferential surface 607 of the distance-measuring wheel 601 is in rolling engagement with an outer surface 611 of the work piece 610. In this regard, a force exerted by the work piece 610 may depress the distance-measuring wheel 601.

A frame structure 608 for supporting the distance-measuring device 600 may be connected to the base structure 604. For example, one or more screws 609 may connect the base structure 604 to the frame structure 608. The frame structure 608 may also connect a miter saw 630 having a blade 631 to the distance-measuring device 600. In this regard, the frame structure 608 may be connectable to the miter saw 630 such that a central axis of the blade is transverse to a central axis of said distance-measuring wheel 601.

As in the earlier embodiments, the distance-measuring device 600 may include a processor in communication with the rotary encoder 602. The processor functions to (i) receive the first signal from the rotary encoder 602, (ii) determine the longitudinal distance traveled by the work piece 610, and (iii) produce a second signal corresponding to the longitudinal distance traveled by the work piece 610.

The processor may be programmed to account for the width of the kerf of the saw blade 631 (i.e., the width of the saw cut). In this regard, those of ordinary skill in the art will appreciate that the total length (TL) of a work piece 610 after being cut is equal to the longitudinal distance it traveled minus the kerf of the saw blade 631. Those of ordinary skill will further appreciate that the kerf of a blade may be wider than the width of the blade. In accounting for the kerf of the saw blade 631, the processor, for example, may subtract the kerf of the saw blade 631 from the actual longitudinal distance traveled by the work piece 610. The processor may be programmed to account for a standard saw blade kerf (e.g., about 0.12 inches), but may also be programmed by a user to account for a nonstandard saw blade kerf.

The processor may also be programmed to account for the saw blade 631 being positioned at an angle when making cuts (e.g., for making an angled cut or a beveled cut).

The distance-measuring device 600 may also include a digital display 615. The digital display 615 may be located in a housing 616. An arm 614 (e.g., a flexible arm) may connect the housing 616 to the base structure 604.

The digital display 615 typically receives the second signal from the processor and displays the longitudinal distance traveled by the work piece 610. Advantageously, display may provide an alpha-numeric representation of the longitudinal distance traveled by the work piece 610 and/or a graphical representation of the longitudinal distance traveled by the work piece 610. FIGS. 18A and 18B depict a digital display 615 providing both an alpha-numeric and a graphical representation of the longitudinal distance traveled by the work piece 610.

In an exemplary embodiment, the distance-measuring device 600 includes a reset switch 617, which may be positioned on the housing 616. In this embodiment, the reset switch 617 is in communication with the processor and upon activation sends a signal to the processor. Upon receiving a signal from the reset switch 617 the processor resets the longitudinal distance traveled by the work piece 610 (i.e., the processor resets to the longitudinal distance traveled to zero).

In another embodiment, the distance-measuring device 600 may include a rotary sensor 618 for detecting when the saw blade 631 is in a down position. This rotary or blade-down sensor 618 is in communication with the processor. In this regard, the blade-down 618 sensor sends a signal to the processor when it detects that the blade 631 is in the down position. Upon receiving a signal from the blade-down sensor 618 the processor resets the longitudinal distance traveled by the work piece 610.

In the drawings and specification, there have been disclosed typical embodiments on the invention and, although specific terms have been employed, they have been used in a generic and descriptive sense only and not for purposes of limitation, the scope of the invention being set forth in the following claims.

1. A device for measuring distance comprising:
an electronic rotary encoder having an input shaft, said electronic rotary encoder producing a first signal that corresponds to a longitudinal motion of a work piece;
a distance-measuring wheel connected to said input shaft, said distance-measuring wheel having an outer circumferential surface in rolling engagement with an outer surface of the work piece;
a processor in communication with said rotary encoder, said processor (i) receiving said first signal, (ii) determining the longitudinal distance traveled by the work piece, and (iii) producing a second signal corresponding to the longitudinal distance traveled by the work piece; and
a housing having an electronic digital display for receiving said second signal and displaying the longitudinal distance traveled by the work piece.

2. A distance-measuring device according to claim 1, wherein said distance-measuring wheel reciprocates along a plane that is transverse to a longitudinal axis of the work piece.

3. A distance-measuring device according to claim 1, wherein said distance-measuring wheel comprises a cylindrical roller.

4. A distance-measuring device according to claim 1, further comprising a reset switch carried by said housing, wherein said reset switch is in communication with said processor, and wherein said processor resets the longitudinal distance traveled by the work piece after receiving a signal from said reset switch.

5. A distance-measuring device according to claim 1, further comprising a frame structure for supporting the distance-measuring device and for connecting a miter saw having a blade to the distance-measuring device.

6. A distance-measuring device according to claim 5, wherein said frame structure is connectable to the miter saw such that the central axis of the saw blade is transverse to the central axis of said distance-measuring wheel.

7. A distance-measuring device according to claim 5, further comprising a blade-down sensor for detecting when the saw blade is in a down position.

8. A distance-measuring device according to claim 7, wherein:
said blade-down sensor is in communication with said processor; and
said processor resets the longitudinal distance traveled by the work piece after receiving a signal from said blade-down sensor.

9. A distance-measuring device according to claim 1, wherein said display provides an alpha-numeric representation of the longitudinal distance traveled by the work piece.

10. A distance-measuring device according to claim 1, wherein said display provides a graphical representation of the longitudinal distance traveled by the work piece.

11. A device for measuring distance comprising:
an electronic rotary encoder having an input shaft, said electronic rotary encoder producing a first signal that corresponds to a longitudinal motion of a work piece;
a distance-measuring wheel connected to said input shaft, said distance-measuring wheel having an outer circumferential surface in rolling engagement with an outer surface of the work piece;
a base structure connected to said distance-measuring wheel;
a frame structure for connecting a miter saw having a blade to the distance-measuring device; wherein said frame structure is connected to said base structure;
a processor in communication with said rotary encoder, said processor (i) receiving said first signal, (ii) determining the longitudinal distance traveled by the work piece, and (iii) producing a second signal corresponding to the longitudinal distance traveled by the work piece; and
a housing having an electronic digital display for receiving said second signal and displaying the longitudinal distance traveled by the work piece.

12. A distance-measuring device according to claim 11, wherein:
said distance-measuring wheel is movably connected to said base structure; and
said distance-measuring wheel is depressible in a direction that is transverse to a longitudinal axis of the work piece.

13. A distance-measuring device according to claim 11, wherein said distance-measuring wheel comprises a cylindrical roller.

14. A distance-measuring device according to claim 11, further comprising a reset switch carried by said housing, said reset switch being in communication with said processor, wherein said processor resets the longitudinal distance traveled by the work piece after receiving a signal from said reset switch.

15. A distance-measuring device according to claim 11, wherein said electronic rotary encoder continuously produces said first signal corresponding to the longitudinal motion of the work piece.

16. A distance-measuring device according to claim 11, wherein said frame structure is connectable to the miter saw such that the central axis of the saw blade is transverse to the central axis of said distance-measuring wheel.

17. A distance-measuring device according to claim 11, further comprising a blade-down sensor for detecting when the saw blade is in a down position.

18. A distance-measuring device according to claim 17, wherein:
said blade-down sensor is in communication with said processor; and
said processor resets the longitudinal distance traveled by the work piece after receiving a signal from said blade-down sensor.

19. A distance-measuring device according to claim 11, wherein said display provides an alpha-numeric representation of the longitudinal distance traveled by the work piece.

20. A distance-measuring device according to claim 11, wherein said display provides a graphical representation of the longitudinal distance traveled by the work piece.
